(19) United States
(12) Patent Application Publication
(10) Pub. No.: US 2022/0389216 A1
(43) Pub. Date: Dec. 8, 2022

(54) MOLDED ARTICLES COMPRISING A POST-CONSUMER RECYCLE POLYCARBONATE AND METHOD FOR THE MANUFACTURE THEREOF

(71) Applicant: SHPP Global Technologies B.V., BERGEN OP ZOOM (NL)

(72) Inventors: Viswanathan KALYANARAMAN, Newburgh, IN (US); Kaushal GANDHI, Newburgh, IN (US); Philip Wesley BELL, Mount Vernon, IN (US); Gregory SHANKWITZ, Fulshear, TX (US)

(21) Appl. No.: 17/770,207

(22) PCT Filed: Dec. 15, 2020
(86) PCT No.: PCT/US2020/064995

§ 371 Date: Apr. 19, 2022

Related U.S. Application Data
(60) Provisional application No. 62/948,484, filed on Dec. 16, 2019.

(51) Int. Cl. C08L 69/00; C08G 64/06; C08J 11/08

(52) U.S. Cl. CPC C08L 69/00; C08G 64/06; C08J 11/08; C08L 2205/025; C08L 2207/20; C08L 2203/30

(57) ABSTRACT

A polycarbonate composition includes particular amounts of a virgin polycarbonate and a purified recycled polycarbonate. The polycarbonate composition can exhibit improved color. The polycarbonate composition can be useful for forming molded articles. A method of purifying a post-consumer or post-industrial recycle polycarbonate composition is also disclosed.

### CROSS-REFERENCE TO RELATED APPLICATION

This application claims priority to and benefit of U.S. Provisional Application No. 62/948,484 filed Dec. 16, 2019, the contents of which is incorporated by reference herein in its entirety.

### BACKGROUND

Thermoplastic polymers are used on a large scale for many applications, including, for example, the manufacture of bottles for packaged beverages. Many bottle manufacturers prefer using colored bottles, with typical bottle colorations including greens, yellows, reds, browns, blues, and mixtures of colors. Thus, during manufacture of said bottles, one or more dyes or colorants are typically admixed with the thermoplastic. Additional additives such as UV stabilizers, antimicrobial agents, antioxidants, light stabilizers, optical brighteners, processing stabilizers, or flame retardants can also be added to the thermoplastic molding composition.

Unfortunately, the use of color in recyclable thermoplastics presents numerous difficulties for future use. The presence of a dye or colorant in the thermoplastic material can be difficult to remove so as to allow for subsequent use of the recycled material, particularly in future applications requiring colorless materials. Despite the research efforts to date, methods to extract colorants and dyes from recycled thermoplastic materials have been unable to remove sufficient amounts of coloration from the recycled materials.

Accordingly, there remains a continuing need in the art for an improved process for purifying recycled thermoplastic materials, in particular, recycled polycarbonate. It would be particularly desirable to provide compositions and molded articles including a purified post-consumer recycle polycarbonate which exhibit improved color (e.g., are substantially colorless).

### BRIEF DESCRIPTION

A polycarbonate composition comprises 1 to 50 weight percent of a virgin polycarbonate; and 50 to 99 weight percent of a purified recycled polycarbonate; wherein weight percent is based on the total weight of the polycarbonate composition.

A molded article comprises the polycarbonate composition and has an L* value of greater than or equal to 95, preferably greater than or equal to 96; a ΔL* of 1 to 4 units lighter, compared to the same molded article comprising an unpurified recycled polycarbonate; or both.

A method of making the molded article comprises melt-mixing the purified recycled polycarbonate the polycarbonate; and forming the molded article.

A method of purifying a post-consumer or post-industrial recycle polycarbonate composition comprises contacting a solution comprising a post-consumer or post-industrial recycle polycarbonate composition, and a solvent effective to dissolve the post-consumer or post-industrial recycle polycarbonate composition, with an activated carbon to provide a purified post-consumer or post-industrial recycle polycarbonate; and isolating the purified post-consumer or post-industrial recycle polycarbonate by spraying a solution comprising the post-consumer or post-industrial recycle polycarbonate through a jet, wherein upon exiting the jet, the solution is contacted with steam to vaporize the solvent and provide the purified post-consumer or post-industrial recycle polycarbonate in the form of a wet cake; wherein a molded article comprising at least 50 weight percent of the purified post-consumer recycle polycarbonate exhibits an L* value of greater than or equal to 95, preferably greater than or equal to 96; a ΔL* of 1 to 4 units lighter, compared to the same molded article comprising an unpurified post-consumer or post-industrial recycle polycarbonate; or both.

### DETAILED DESCRIPTION

Disclosed herein are polycarbonate compositions comprising a blend of a virgin polycarbonate and a purified post-consumer or post-industrial recycled polycarbonate. The present inventors have found that using a particular purification method, also disclosed herein, a purified post-consumer or post-industrial recycled polycarbonate can be obtained which can advantageously be used as a major component (i.e., greater than or equal to 50 weight percent) of a polycarbonate composition. Unexpectedly, the polycarbonate composition including the purified post-consumer or post-industrial recycled polycarbonate in an amount of greater than or equal to 50 weight percent can exhibit good color properties. In particular, the compositions, and molded articles formed therefrom can be sufficiently colorless. Accordingly, the present disclosure can provide compositions and articles comprising a purified post-consumer or post-industrial recycle polycarbonate as a major component and show improvement in L* value as well as in transmission, enabling the use of recycled polycarbonate in applications which require a broader color space, in particular, a bright white color space. In a further advantageous feature, the present application provides a method for purifying a post-consumer recycle polycarbonate which avoids multi-solvent extractions or precipitations, or depolymerization to the monomer constituents.

Accordingly, an aspect of this disclosure is a polycarbonate composition. The polycarbonate composition includes a virgin polycarbonate. As used herein, the term “virgin polycarbonate” refers to a polycarbonate that has not been used in end-use parts, articles, or components.

“Polycarbonate” as used herein means a homopolymer or copolymer having repeating structural carbonate units of formula (1)

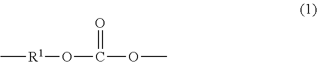

wherein at least 60 percent of the total number of R¹ groups are aromatic, or each R¹ contains at least one C₆₋₃₀ aromatic group. Preferably, each R¹ can be derived from a dihydroxy compound such as an aromatic dihydroxy compound of formula (2) or a bisphenol of formula (3).

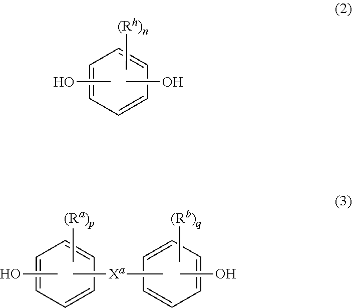

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{h} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an aspect, p and q is each 0, or p and q is each 1, and R^{a} and R^{h} are each a C₁₋₃ alkyl group, preferably methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(=R^{e})— wherein R^{e} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha'-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′- tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

“Polycarbonate” as used herein also includes copolymers comprising carbonate units and ester units (“poly(ester-carbonate)s”, also known as polyester-polycarbonates). Poly(ester-carbonate)s further contain, in addition to recurring carbonate chain units of formula (1), repeating ester units of formula (4)

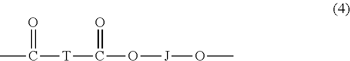

wherein J is a divalent group derived from a dihydroxy compound (which includes a reactive derivative thereof), and can be, for example, a C₁₋₁₀ alkylene, a C₆₋₂₀ cycloalkylene, a C₅₋₂₀ arylene, or a polyoxyalkylene group in which the alkylene groups contain 2 to 6 carbon atoms, preferably, 2, 3, or 4 carbon atoms; and T is a divalent group derived from a dicarboxylic acid (which includes a reactive derivative thereof), and can be, for example, a C₁₋₂₀ alkylene, a C₅₋₂₀ cycloalkylene, or a C₆₋₂₀ arylene. Copolyesters containing a combination of different T or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,4-cyclohexane diol, 1,4-hydroxymethylcyclohexane, or a combination thereof dihydroxy compounds. Aliphatic dicarboxylic acids that can be used include C₅₋₂₀ aliphatic dicarboxylic acids (which includes the terminal carboxyl groups), preferably linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,4-cyclohexane dicarboxylic acid, or a combination thereof acids. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example from 1:99 to 99:1, or from 10:90 to 90:10, or from 20:80 to 80:20, or from 1:99 to 50:50, or from 50:50 to 99:1.

In an aspect, the polycarbonate can be a a poly(carbonate-siloxane), alse referred to in the art as a polycarbonate-polysiloxane copolymer. The polysiloxane blocks comprise repeating diorganosiloxane units as in formula (5)

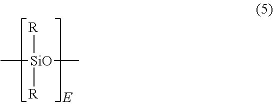

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (5) can vary widely depending on the type and relative amount of each component in the thermoplastic composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polysiloxane blocks are of formula (6)

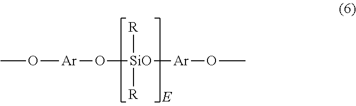

wherein E and R are as defined in formula (5); each R can be the same or different, and is as defined above; and Ar can be the same or different, and is a substituted or unsubstituted C₆₋₃₀ arylene, wherein the bonds are directly connected to an aromatic moiety. Ar groups in formula (6) can be derived from a C₆₋₃₀ dihydroxyarylene compound. Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (7)

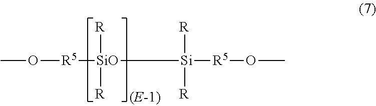

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (8):

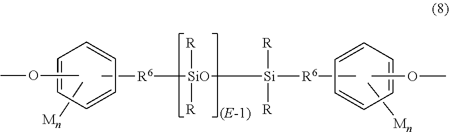

wherein R and E are as defined above. R⁶ in formula (8) is a divalent C₂₋₈ aliphatic group. Each M in formula (8) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C7-12 alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

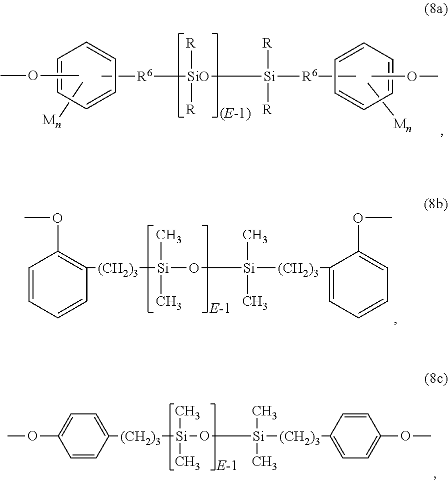

or a combination thereof, wherein E has an average value of 2 to 200, 2 to 125, 5 to 125, 5 to 100, 5 to 50, 20 to 80, or 5 to 20.

Blocks of formula (8) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (8a), (8b), (8c), or a combination thereof (preferably of formula 8a), wherein E has an average value of 4 to 50, 4 to 15, preferably 5 to 15, more preferably 6 to 15, and still more preferably 7 to 10. The transparent copolymers can be manufactured using one or both of the tube reactor processes described in U.S. Patent Application No. 2004/0039145A1 or the process described in U.S. Pat. No. 6,723,864 can be used to synthesize the poly(carbonate-siloxane) copolymers.

The poly(carbonate-siloxane) copolymers can comprise 50 to 99 weight percent of carbonate units and 1 to 50 weight percent siloxane units. Within this range, the poly(carbonate-siloxane) copolymer can comprise 70 to 98 weight percent, more preferably 75 to 97 weight percent of carbonate units and 2 to 30 weight percent, more preferably 3 to 25 weight percent siloxane units.

Polycarbonates can also be branched polycarbonates. Various types of branching agents can be utilized. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride (TMTC), tris-p-hydroxy phenyl ethane (THPE), 3,3-bis-(4-hydroxyphenyl)-oxindole (also known as isatin-bis-phenol), tris-phenol TC (1,3,5- tris((p-hydroxyphenyl)isopropyl)benzene), tris-phenol PA (4(4(1,1-bis(p-hydroxyphenyl)- ethyl) alpha, alpha-dimethyl benzyl)phenol), 4-chloroformyl phthalic anhydride, trimesic acid, and benzophenone tetracarboxylic acid. Examples of specific branching agents that are particularly effective in embodiments include trimellitic trichloride (TMTC), tris-p-hydroxy phenyl ethane (THPE) and isatin-bis-phenol. The branching agents can be added at a level of 0.05 to 2.0 wt % based on the total weight of the polycarbonate. The amount of branching agent can provide 0.1 to 10 branching units per 100 R¹ units, or 0.5 to 8 branching units per 100 R¹ units, or 0.75 to 5 branching units per 100 R¹ units.

Mixtures of any of the foregoing polycarbonates can be used.

In an aspect, the polycarbonate is a linear homopolymer containing bisphenol A carbonate units (BPA-PC), commercially available, for example, under the trade name LEXAN from SABIC; or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from SABIC. A combination of a linear polycarbonate and a branched polycarbonate can be used. It is also possible to use a polycarbontate copolymer or interpolymer rather than a homopolymer. Polycarbonate copolymers can include copolycarbonates comprising two or more different types of carbonate units, for example units derived from BPA and PPPBP (commercially available under the trade name XHT or CXT from SABIC); BPA and DMBPC (commercially available under the trade name DMX from SABIC); or BPA and isophorone bisphenol (commercially available under the trade name APEC from Bayer). The polycarbonate copolymers can further comprise non-carbonate repeating units, for example repeating ester units (polyester-carbonates), such as those comprising resorcinol isophthalate and terephthalate units and bisphenol A carbonate units, such as those commercially available under the trade name LEXAN SLX from SABIC; bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units; or bisphenol A carbonate units and C6-12 dicarboxy ester units such as sebacic ester units (commercially available under the trade name HFD from SABIC) Other polycarbonate copolymers can comprise repeating siloxane units (polycarbonate-siloxanes), for example those comprising bisphenol A carbonate units and siloxane units (e.g., blocks containing 5 to 200 dimethylsiloxane units), such as those commercially available under the trade name EXL from SABIC; or both ester units and siloxane units (polycarbonate-ester-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from SABIC. Combinations of any of the above materials can be used.

In a specific aspect, the virgin polycarbonate can comprise a bisphenol A homopolycarbonate, a copolycarbonate comprising bisphenol A carbonate units and 1,1-bis(4-hydroxy-3-methylphenyl)cyclohexane carbonate units, a copolycarbonate comprising bisphenol A carbonate units and 2-phenyl-3,3′-bis(4-hydroxyphenyl) phthalimidine carbonate units, a copolycarbonate comprising bisphenol A carbonate units and siloxane units, or a combination thereof.

The virgin polycarbonate can be present in the composition in an amount of 1 to 50 weight percent, based on the total weight of the polycarbonate composition. Within that range, the virgin polycarbonate can be present in an amount of at least 5 weight percent, or at least 10 weight percent, or at least 15 weight percent, or at least 20 weight percent, or at least 25 weight percent, or at least 30 weight percent, or at least 35 weight percent. Also within that range, the virgin polycarbonate can be present in an amount of less than or equal to 35 weight percent, or less than or equal to 30 weight percent, or less than or equal to 25 weight percent, or less than or equal to 20 weight percent, or less than or equal to 15 weight percent, or less than or equal to 10 weight percent, or less than or equal to 5 weight percent. For example, the virgin polycarbonate can be present in an amount of 10 to 40 weight percent, or 10 to 30 weight percent, or 15 to 25 weight percent.

In addition to the virgin polycarbonate, the polycarbonate composition of the present disclosure further comprises a purified recycled polycarbonate comprising a purified post-consumer recycle polycarbonate, a purified post-industrial recycle polycarbonate, or a combination thereof. As used herein, the term “post-consumer recycle polycarbonate” refers to a polycarbonate that has reached the intended user or consumer and which is no longer being used for its intended purpose, and which has been collected or reclaimed after utilization by the end-user or consumer. Thus, for example, it is understood that that the term refers to a polycarbonate material that would have otherwise been disposed of as waste, but has instead been collected and recovered (reclaimed) as a material input, in lieu of a new virgin material, for a recycling or manufacturing process. The term is inclusive of such collected or reclaimed materials which have been further treated or processed to facilitate re-use of the material. Thus, for example, the term is inclusive of material that has been reprocessed from collected or reclaimed material by means of a manufacturing process and made into a product or into a component for incorporation into a product. Such recycled polycarbonates can be further processed to ground materials, flakes, or in the form of pellets. As used herein, the term “post-industrial recycle polycarbonate” refers to a polycarbonate polymer or polymers that has never reached the end user and that is production waste arising during polymerization reactions, e.g. polycondensation, during further processing, or during manufacturing an article and includes materials such as, but not limited to, sprues from injection molding, start-up material from injection molding or extrusion, extrusion scrap, molding scrap, edge trims from extruded sheets or films, and the like, including materials diverted from the waste stream during a manufacturing process for an article.

The purified post-consumer or post-industrial recycle polycarbonate comprises a polycarbonate which can be as described above. In an aspect, the purified post-consumer or post-industrial recycle polycarbonate comprises a homopolycarbonate, for example a bisphenol A homopolycarbonate. The purified post-consumer or post-industrial recycle polycarbonate can be obtained by purifying a post-consumer or post-industrial recycle polycarbonate composition according to the method described herein. The purified post-consumer or post-industrial recycle polycarbonate can comprise residual amounts of one or more additives that were present in the post-consumer or post-industrial polycarbonate composition prior to purification.

In an aspect, the purified post-consumer or post-industrial recycle polycarbonate is prepared according to a method comprising: contacting a solution comprising a post-consumer or post-industrial recycle polycarbonate composition, and a solvent effective to dissolve the post-consumer or post-industrial recycle polycarbonate composition, with an activated carbon; and isolating the purified post-consumer or post-industrial recycle polycarbonate. The method of purifying the post-consumer or post-industrial recycle polycarbonate is further described in detail below.

The purified post-consumer or post-industrial recycle polycarbonate can be present in the composition in an amount of 50 to 99 weight percent, based on the total weight of the composition. Within this range, the purified post-consumer or post-industrial recycle polycarbonate can be present in an amount of at least 55 weight percent, or at least 60 weight percent, or at least 65 weight percent, or at least 70 weight percent, or at least 75 weight percent, or at least 80 weight percent, or at least 85 weight percent, or at least 90 weight percent, or at least 95 weight percent. Also within this range, the purified post-consumer or post-industrial recycle polycarbonate can be present in an amount of less than or equal to 95 weight percent, or less than or equal to 90 weight percent, or less than or equal to 85 weight percent, or less than or equal to 80 weight percent, or less than or equal to 75 weight percent, or less than or equal to 70 weight percent, or less than or equal to 65 weight percent, or less than or equal to 60 weight percent, or less than or equal to 55 weight percent. For example, in an aspect, the purified post-consumer or post-industrial recycle polycarbonate can be present in the composition in an amount of 60 to 90 weight percent, or 70 to 90 weight percent, or 75 to 85 weight percent.

In an aspect, the composition can comprise a virgin polycarbonate and a purified post-consumer or post-industrial recycle polycarbonate, wherein each of the virgin and the purified post-consumer recycle polycarbonates can be as described in Table 1 below. The acronyms for each of the polymers are defined above. The amount of each polymer component is given in weight percent, based on the total weight of the purified post-consumer or post-industrial recycle polycarbonate and the virgin polycarbonate. As shown in Table 1, the each of the virgin and the purified post-consumer or post-industrial recycle polycarbonate can comprise a single polycarbonate (columns 1-16). Alternatively, each of the virgin and the purified post-consumer or post-industrial recycle polycarbonate can independently comprise two or more polycarbonate components. The compositions presented in Table 1 are examples of compositions falling within the scope of the present disclosure, and are non-limiting.

TABLE 1

| | | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|---|
| Purified | BPA-PC | 50-99 | 50-99 | 50-99 | 50-99 | | | | | | | | | | | | |
| post- | BPA/PPPBP- | | | | | 50-99 | 50-99 | 50-99 | 50-99 | | | | | | | | |
| consumer | PC | | | | | | | | | | | | | | | | |
| polycarbonate | BPA/DMBPC- | | | | | | | | | 50-99 | 50-99 | 50-99 | 50-99 | | | | |
| | PC | | | | | | | | | | | | | | | | |
| | BPA/Si-PC | | | | | | | | | | | | | 50-99 | 50-99 | 50-99 | 50-99 |
| Virgin | BPA-PC | 1-50 | | | | 1-50 | | | | 1-50 | | | | 1-50 | | | |
| polycarbonate | BPA/PPPBP- | | 1-50 | | | | 1-50 | | | | 1-50 | | | | 1-50 | | |
| | PC | | | | | | | | | | | | | | | | |
| | BPA/DMBPC- | | | 1-50 | | | | 1-50 | | | | 1-50 | | | | 1-50 | |
| | PC | | | | | | | | | | | | | | | | |
| | BPA/Si-PC | | | | 1-50 | | | | 1-50 | | | | 1-50 | | | | 1-50 |

The polycarbonate composition can optionally further comprise various additives ordinarily incorporated into polycarbonate compositions, with the proviso that the additive(s) are selected so as to not significantly adversely affect the desired properties of the polycarbonate composition, in particular the color of the composition. Such additives can be mixed at a suitable mixing time during the mixing of the components for forming the composition. Additives can include, for example, impact modifiers, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of a stabilizer (e.g., a heat stabilizer), a flame retardant, and a color package. In general, the additives can be used in the amounts generally known to be effective. For example, the total amount of the additives (other than any impact modifier, filler, or reinforcing agent) can be 0.001 to 10.0 wt %, or 0.01 to 5 wt %, each based on the total weight of the polymer in the composition.

Heat stabilizer additives include organophosphites (e.g. triphenyl phosphite, tris-(2,6-dimethylphenyl)phosphite, tris-(mixed mono-and di-nonylphenyl)phosphite or the like), phosphonates (e.g, dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS™ 168. Heat stabilizers are generally used in amounts of 0.01 to 5 wt %, based on the total weight of polymer in the composition.

Useful flame retardants include organic compounds that include phosphorus, bromine, or chlorine. Non-brominated and non-chlorinated phosphorus-containing flame retardants can be preferred in certain applications for regulatory reasons, for example organic phosphates and organic compounds containing phosphorus-nitrogen bonds.

Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di- or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts. Flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. When used, phosphorus-containing flame retardants are present in amounts of 0.1 to 30 parts by weight, more preferably 1 to 20 parts by weight, based on 100 parts by weight of the total composition, excluding any filler.

Halogenated materials can also be used as flame retardants, for example bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis- (3-phenyl-4-bromophenyl)-ethane; 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants are present in amounts of 1 to 25 parts by weight, more preferably 2 to 20 parts by weight, based on 100 parts by weight of the total composition, excluding any filler.

Alternatively, the thermoplastic composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition, excluding any filler.

Inorganic flame retardants can also be used, for example salts of C1-16 alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO_{3,} K₂CO_{3,} MgCO_{3,} CaCO_{3,} and BaCO_{3,} or fluoro-anion complexes such as Li₃AlF_{6,} BaSiF_{6,} KBF_{4,} K₃AlF_{6,} KAlF_{4,} K₂SiF_{6,} or Na₃AlF₆. When present, inorganic flame retardant salts are present in amounts of 0.01 to 10 parts by weight, more preferably 0.02 to 1 parts by weight, based on 100 parts by weight of the total composition, excluding any filler.

Colorants such as pigment or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or a combination thereof.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,T-p-phenylen-bis(5-phenyloxazole); rhodamine 700; rhodamine 800; pyrene, chrysene, rubrene, coronene, or the like; or a combination thereof.

Advantageously, the polycarbonate composition can exhibit improved color even with the post-consumer or post-industrial recycle polycarbonate constituting a major portion of the composition. For example, a molded article comprising the composition can exhibit an L* value of greater than or equal to 95, preferably greater than or equal to 96. A molded article comprising the composition can also exhibit an improvement in L* value relative to the same composition except where the post-consumer or post-industrial recycle polycarbonate has not been purified (i.e., used as received). For example, a molded article comprising the polycarbonate composition can exhibit a ΔL* of 1 to 4 units lighter.

The polycarbonate composition of the present disclosure can be particularly useful for forming molded articles. As discussed above, the molded articles can advantageously have an L* value of greater than or equal to 95, preferably greater than or equal to 96; a ΔL* of 1 to 4 units lighter, compared to the same molded article comprising an unpurified post-consumer or post-industrial recycle polycarbonate; or both. Molded articles can include, for example, a lens, cover, sheet, film, or consumer electronic component. In an aspect, the molded article is a consumer electronic component, for example, an enclosure or part for a laptop, a desktop computer, a cellular phone, a camera, or a docking station.

Articles can be formed from the composition by a method comprising melt-mixing the purified post-consumer or post-industrial recycle polycarbonate, and the virgin polycarbonate, and forming the article. Forming the article can be by, for example, extrusion, injection molding, thermoforming, compression molding, rotomolding, and the like, or any combination thereof.

Another aspect of the present disclosure is a method of purifying a post-consumer or post-industrial recycle polycarbonate composition to provide a purified post-consumer or post-industrial recycle polycarbonate. The resulting purified post-consumer or post-industrial recycle polycarbonate is as described above, and is particularly useful in the aforementioned compositions and articles.

The method comprises contacting a solution comprising a post-consumer or post-industrial recycle polycarbonate composition and a solvent effective to dissolve the post-consumer or post-industrial recycle polycarbonate composition with an activated carbon. The post-consumer or post-industrial recycle polycarbonate composition and the solvent can be combined such that the resulting solution preferably has a solids content (i.e., weight percent of post-consumer or post-industrial recycle polycarbonate composition, based on the total weight of the post-consumer recycle polycarbonate composition and the solvent) of 5 to 15 weight percent, or 5 to 10 weight percent, or 5 to 8 weight percent. The post-consumer or post-industrial recycle polycarbonate composition should generally be soluble in the solvent at a temperature of 15 to 35° C.

The post-consumer or post-industrial recycle polycarbonate composition comprises a polycarbonate, and can be as described above. The post-consumer or post-industrial recycle polycarbonate composition can be sourced from one or more consumer products, including but not limited to, water bottles, CD/DVD scrap, automotive lens scrap, consumer electronics, and the like.

The post-consumer or post-industrial recycle polycarbonate composition can further comprise a colorant, for example, a dye or a pigment. Dyes or pigments present in the post-consumer or post-industrial recycle polycarbonate composition can be as described above. In an aspect, the post-consumer or post-industrial recycle polycarbonate composition can comprise up to 10 weight percent of the colorant, or up to 5 weight percent of the colorant, based on the total weight of post-consumer or post-industrial recycle polycarbonate composition.

The post-consumer or post-industrial recycle polycarbonate composition can further optionally comprise one or more additional residual additives. For example, the post-consumer or post-industrial recycle polycarbonate composition can further include an impact modifier. Examples of impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like. Other additives that can optionally be present can include a flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, surface effect additive, radiation stabilizer, flame retardant, anti-drip agent (e.g., a PTFE-encapsulated styrene-acrylonitrile copolymer (TSAN)), or a combination thereof. Additives (other than any impact modifier, filler, or reinforcing agent) are generally present in an amount of less than or equal to 10 weight percent, for example 0.001 to 10.0 wt %, or 0.01 to 5 wt %, each based on the total weight of the polymer in the composition.

In addition to the post-consumer or post-industrial recycle polycarbonate composition, the solution comprises a solvent effective to dissolve the post-consumer recycle polycarbonate composition. The solvent can have a boiling point of less than 160° C., preferably less than 100° C. The solvent can comprise, for example, methylene chloride, chloroform, ethylene chloride, 1,4-dioxane, furan, cyclopentanone, anisole, carbon tetrachloride, dichloroethane, trichloroethane, dichloroethylene, trichloroethylene, chloropropane, dichloropropane, fluorochloropropane, chloropropene, dichloropropene, fluorochloro propene, toluene, chlorobenzene, or a combination comprising at least one of the foregoing. In an aspect, the solvent comprises a halogenated alkane solvent. In an aspect, the solvent preferably comprises methylene chloride.

The solution comprising the post-consumer or post-industrial recycle polycarbonate composition and the solvent is contacted with an activated carbon. The activated carbon can be, for example, derived from bituminous coal, anthracite coal, coconut shell, coal, or a combination comprising at least one of the foregoing. Examples of suitable activated carbons can include, for example, DARCO G-60, available from Fisher Scientific, or ULTRACARB 1240AW, AQUACARB 1240AWC, BEVCARB1240, and AQUACARB 1240AW, each commercially available from Evoqua Water Technologies LLC. In an aspect, the activated carbon can have a mesh size of 12×40. Stated another way, at least 93% of the activated carbon particles by weight are larger than 0.42 millimeters, and at least 90% of the activated carbon particles by weight are smaller than 1.70 millimeters.

In an aspect, the activated carbon can be added directly to the solution to provide a slurry. The resulting slurry can be agitated under conditions effective to decolorize the solution. For example, the slurry can be agitated for 15 minutes to 24 hours at a temperature of 15 to 35° C. The activated carbon can be added to the solution in an amount effective to decolorize the post-consumer or post-industrial recycle polycarbonate solution. For example, greater than or equal to 0.05 weight percent of the activated carbon can be added to the solution, based on the total weight of the post-consumer or post-industrial recycle polycarbonate composition. For example, greater than 0.1 weight percent, preferably greater than or equal to 0.25 weight percent, more preferably 0.25 to 6 weight percent, even more preferably 0.25 to 2.5 weight percent of the activated carbon can be added to the solution, based on the total weight of the post-consumer or post-industrial recycle polycarbonate composition.

When a slurry is formed, the method further comprises filtering the slurry to provide a filtered solution. Filtering the slurry can comprise using a filter having a pore size of less than 2 micrometers, preferably less than 1 micrometers, more preferably less than 0.45 micrometers, more preferably less than or equal to 0.2 micrometers.

Optionally, prior to contacting the solution with the activated carbon, the solution can be filtered to remove various impurities from the solution that can be present in the as-received post-consumer or post-industrial recycle polycarbonate. Without wishing to be bound by theory, it is believed that such a pre-filtration step can aid in the removal of insoluble components, for example reinforcing fillers such as glass fibers prior to contacting the solution with the activated carbon.

The purified post-consumer or post-industrial recycle polycarbonate can be isolated from the filtered solution by various isolation processes including, for example, steam precipitation, hot water precipitation, non-solvent precipitation, spray drying, devolatilization extruder, and the like or a combination thereof. In an aspect, isolation by steam precipitation and hot-water isolation can be preferred. In a specific embodiment, the purified post-consumer or post-industrial recycle polycarbonate can be isolated from the filtered solution by steam precipitation, in particular by spraying the solution through a jet, wherein upon exiting the jet, the solution is contacted with steam to vaporize the solvent and provide the purified post- consumer or post-industrial recycle polycarbonate in the form of a wet cake. The wet cake can optionally be further dried, for example at a temperature of greater than 50° C., and optionally under reduced pressure to provide a dried, purified post-consumer or post-industrial recycle polycarbonate powder.

Alternatively, in an aspect, the solution can be contacted with the activated carbon by passing the solution through a bed of the activated carbon. The solution can have a residence time of at least 1 second and up to 2000 minutes in the activated carbon bed to provide a purified post-consumer or post-industrial recycle polycarbonate stream. The purified post-consumer or post-industrial recycle polycarbonate can be isolated by spraying the purified post-consumer recycle polycarbonate stream through a jet, wherein upon exiting the jet, the solution is contacted with steam to vaporize the solvent and provide the purified post-consumer recycle polycarbonate in the form of a wet cake. The wet cake can optionally be further dried, for example at a temperature of greater than 50° C., and optionally under reduced pressure to provide a dried, purified post-consumer or post-industrial recycle polycarbonate powder.

Optionally, the purified post-consumer or post-industrial recycle polycarbonate wet cake obtained can be washed with water to remove any water soluble impurities present. The water can have a neutral pH, an acidic pH, or a basic pH.

Advantageously, the method described herein can provide a purified post-consumer or post-industrial recycle polycarbonate having improved color. For example, a molded article comprising at least 50 weight percent of the purified post-consumer or post-industrial recycle polycarbonate exhibits an L* value of greater than or equal to 95, preferably greater than or equal to 96; an ΔL* of 1 to 4 units lighter when compared to the same molded article comprising an unpurified post-consumer or post-industrial recycle polycarbonate; or both.

The purified post-consumer or post-industrial recycle polycarbonate can further exhibit an improvement in transmission, indicated by reduced absorption measured using UV/Vis spectroscopy.

Thus, the method of the present disclosure has provided access to purified post-consumer or post-industrial recycle polycarbonates which can be successfully reused for new applications in a meaningful amount (e.g., greater than or equal to 50 weight percent). Articles including the purified post-consumer or post-industrial recycle polycarbonate composition can also now achieve bright white colors, with an improvement in the L* values of 1 to 4 units lighter, relative to compositions including the as-received post-consumer or post-industrial recycle polycarbonate.

This disclosure is further illustrated by the following examples, which are non-limiting.

### EXAMPLES

Color can be characterized according to the CIE L*, a*, b* color system according to ISO 11664-4:2008(E)/CIE S 014-4 /E:2007, with color measurements made according to ASTM D2244-11 more specifically using a X-Rite Spectrophotometer. L* indicates the lightness or darkness of a sample, with higher values representing lighter colors; a* indicates red/green, with negative values indicating how green a sample is and positive values indicating redness; b* indicates blue/yellow, with negative values indicating blueness, and positive values indicating yellowness.

Molecular weight measurements can be performed using gel permeation chromatography (GPC) in methylene chloride relative to polycarbonate standards.

### Prophetic Example 1: Post-Consumer Recycle Polycarbonate Purification

A transparent post-consumer recycle polycarbonate (PCR-PC) can be purified according to the following general procedure. PCR-PC is dissolved in a solvent such as methylene chloride to provide a 5-10 weight percent solids solution. The contents are shaken until a homogenous solution is formed. To this solution, activated carbon is added in an amount of 2 weight percent, based on the total weight of the PCR-PC, and shaking is continued for 2 hours. The resulting slurry is filtered through a fine glass frit (CG-1402-28) and a Buchner funnel. The resulting filtered polymer solution is sprayed through a jet where it is mixed with steam, resulting in precipitation of the polycarbonate and vaporization of the bulk of the solvent (e.g., methylene chloride). The resulting polycarbonate wet cake can be pulverized to a fine powder and later dried.

### Prophetic Example 2: Blends of Purified Post-Consumer Recycle Polycarbonate

The dried polycarbonate powder obtained by the method above can be mixed with virgin polycarbonate powder, for example a bisphenol A polycarbonate having a molecular weight of 29,000 grams per mole, obtained as LEXAN 100 from SABIC. The purified recycle polycarbonate and the virgin polycarbonate can be mixed in a weight ratio of 50:50 weight/weight. Optionally, various additives such as a phosphite stabilizer can be added. A typical color package containing TiO2, a blue colorant, an optical whitening agent, and a yellow colorant can also be , for example in an amount in the range of 3 to 7 weight percent based on the weight of the polycarbonate blend. The polymer blend can be extruded in a twin-screw lab scale extruder at 550 ° F., and the resulting pellets can be molded into 2×3″ color plaques. The color of the molded plaques can be determined using a spectrophotometer for measuring L*, a*, b* values.

Advantageously, blends comprising the purified post-consumer recycle polycarbonate can exhibit improved color, in particular improved L* relative to the corresponding blends prepared using the as-received post-consumer recycle polycarbonate. For example, the blends comprising the purified post-consumer recycle polycarbonate can exhibit an L* of at least 94, or at least 95, or at least 96. For example, the blends comprising the purified post-consumer recycle polycarbonate can exhibit a change in L* (“ΔL*) of 1 to 4 units, or 2 to 3 units lighter relative to the corresponding blends prepared using the as-received post-consumer recycle polycarbonate.

Improvement in the color can also be determined using a solution of the purified post-consumer recycle polycarbonate dissolved in a solvent. The polymer solution can be analyzed by UV/Vis Spectroscopy, for example using a Perkin-Elmer Lambda 950. Solutions comprising the purified post-consumer recycle polycarbonate can exhibit a decrease in absorption relative to a corresponding solution comprising the as-received post-consumer recycle polycarbonate.

Thus, a significant improvement is provided by the present disclosure.

This disclosure further encompasses the following aspects.

Aspect 1: A polycarbonate composition comprising 1 to 50 weight percent of a virgin polycarbonate; and 50 to 99 weight percent of a purified recycled polycarbonate comprising a purified post-consumer recycle polycarbonate, a purified post-industrial polycarbonate, or a combination thereof; wherein weight percent is based on the total weight of the polycarbonate composition.

Aspect 2: The polycarbonate composition of aspect 1, wherein a molded article comprising the polycarbonate composition exhibits an L* value of greater than or equal to 95, preferably greater than or equal to 96.

Aspect 3: The polycarbonate composition of aspect 1 or 2, wherein a molded article comprising the polycarbonate composition exhibits a ΔL* of 1 to 4 units lighter, compared to the same molded article comprising an unpurified post-consumer or post-industrial recycle polycarbonate.

Aspect 4: The polycarbonate composition of any one or more of aspects 1 to 3, wherein the purified post-consumer or post-industrial recycle polycarbonate comprises a bisphenol A homopolycarbonate.

Aspect 5: The polycarbonate composition of any one or more of aspects 1 to 4, wherein the virgin polycarbonate comprises a bisphenol A homopolycarbonate, a copolycarbonate comprising bisphenol A carbonate units and 1,1-bis(4-hydroxy-3-methylphenyl)cyclohexane carbonate units, a copolycarbonate comprising bisphenol A carbonate units and 2-phenyl-3,3′-bis(4-hydroxyphenyl) phthalimidine carbonate units, a copolycarbonate comprising bisphenol A carbonate units and siloxane units, or a combination thereof.

Aspect 6: The polycarbonate composition of any one or more of claims 1 to 5, comprising 10 to 40 weight percent, or 10 to 30 weight percent, or 15 to 25 weight percent of the virgin polycarbonate; and 60 to 90 weight percent, or 70 to 90 weight percent, or 75 to 85 weight percent of the purified post-consumer or post-industrial recycle polycarbonate.

Aspect 7: The polycarbonate composition of any one or more of aspects 1 to 6, further comprising an additive composition; preferably wherein the additive composition comprises impact modifier, flow modifier, filler, reinforcing agent, antioxidant, heat stabilizer, light stabilizer, ultraviolet (UV) light stabilizer, UV absorbing additive, plasticizer, lubricant, release agent, antistatic agent, anti-fog agent, antimicrobial agent, colorant, surface effect additive, radiation stabilizer, flame retardant, anti-drip agent, or a combination thereof; preferably wherein the additive composition is present in an amount of up to 10 weight percent based on the total weight of polymer in the composition.

Aspect 8: The polycarbonate composition of any one or more of aspects 1 to 7, wherein the purified post-consumer or post-industrial recycle polycarbonate is prepared according to a method comprising: contacting a solution comprising a post-consumer or post-industrial recycle polycarbonate composition, and a solvent effective to dissolve the post-consumer or post-industrial recycle polycarbonate composition, with an activated carbon; and isolating the purified post-consumer or post-industrial recycle polycarbonate.

Aspect 9: A molded article comprising the polycarbonate composition of any one or more of aspects 1 to 8, wherein the molded article has an L* value of greater than or equal to 95, preferably greater than or equal to 96; an ΔL* of 1 to 4 units lighter, compared to the same molded article comprising an unpurified post-consumer or post-industrial recycle polycarbonate; or both.

Aspect 10: The molded article of aspect 9, wherein the molded article is a lens, cover, sheet, film, or consumer electronic component, preferably an enclosure or part for a laptop, a desktop computer, a cellular phone, a camera, or a docking station.

Aspect 11: A method of making the molded article of aspects 9 or 10, the method comprising melt-mixing the purified post-consumer or post-industrial recycle polycarbonate and the virgin polycarbonate; and forming the molded article.

Aspect 12: A method of purifying a post-consumer or post-industrial recycle polycarbonate composition, the method comprising: contacting a solution comprising a post-consumer or post-industrial recycle polycarbonate composition, and a solvent effective to dissolve the post-consumer or post-industrial recycle polycarbonate composition, with an activated carbon to provide a purified post-consumer or post-industrial recycle polycarbonate; and isolating the purified post-consumer or post-industrial recycle polycarbonate by spraying a solution comprising the post-consumer or post-industrial recycle polycarbonate through a jet, wherein upon exiting the jet, the solution is contacted with steam to vaporize the solvent and provide the purified post-consumer or post-industrial recycle polycarbonate in the form of a wet cake; wherein a molded article comprising at least 50 weight percent of the purified post-consumer recycle polycarbonate exhibits an L* value of greater than or equal to 95, preferably greater than or equal to 96; an ΔL* of 1 to 4 units lighter, compared to the same molded article comprising an unpurified post-consumer or post-industrial recycle polycarbonate; or both.

Aspect 13: The method of aspect 12, wherein the post-consumer or post-industrial recycle polycarbonate composition is present in the solution an amount of 5 to 15 weight percent, or 5 to 10 weight percent, or 5 to 8 weight percent, based on the total weight of the solution.

Aspect 14: The method of aspect 12 or 13, wherein contacting the solution with the activated carbon comprises adding the activated carbon to the solution to provide a slurry, filtering the slurry to provide a filtered solution, and spraying the filtered solution through the jet to isolate the purified post-consumer or post-industrial recycle polycarbonate, preferably wherein the slurry is agitated for 15 minutes to 24 hours at a temperature of 15 to 35° C.; or passing the solution through a bed of activated carbon, preferably wherein the solution has a residence time in the bed of 1 second to 2000 minutes.

Aspect 15: The method of aspect 14, wherein contacting the solution with the activated carbon comprises adding the activated carbon to the solution to provide the slurry, wherein greater than or equal to 0.05 weight percent of the activated carbon is added to the solution, based on the total weight of the post-consumer recycle polycarbonate composition, preferably wherein greater than 0.1 weight percent, more preferably greater than or equal to 0.25 weight percent, more preferably 0.25 to 6 weight percent, even more preferably 0.25 to 2.5 weight percent of the activated carbon is added to the solution, based on the total weight of the post-consumer or post-industrial recycle polycarbonate composition.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. The term “combination thereof” as used herein includes one or more of the listed elements, and is open, allowing the presence of one or more like elements not named. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC=CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CⁿHₙ₂₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, 0, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(=O)₂-alkyl), a C₆₋₁₂ aryl sulfonyl (—S(=O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polycarbonate composition comprising
1 to 50 weight percent of a virgin polycarbonate; and
50 to 99 weight percent of a purified recycled polycarbonate comprising purified post-consumer recycle polycarbonate, purified post-industrial recycle polycarbonate, or a combination thereof;
wherein weight percent is based on the total weight of the polycarbonate composition.

2. The polycarbonate composition of claim 1, wherein a molded article comprising the polycarbonate composition exhibits an L* value of greater than or equal to 95.

3. The polycarbonate composition of claim 1, wherein a molded article comprising the polycarbonate composition exhibits a ΔL* of 1 to 4 units lighter, compared to the same molded article comprising an unpurified post-consumer recycle polycarbonate.

4. The polycarbonate composition of claim 1, wherein the purified recycled polycarbonate comprises a bisphenol A homopolycarbonate.

5. The polycarbonate composition of claim 1, wherein the virgin polycarbonate comprises a bisphenol A homopolycarbonate, a copolycarbonate comprising bisphenol A carbonate units and 1,1-bis(4-hydroxy-3-methylphenyl)cyclohexane carbonate units, a copolycarbonate comprising bisphenol A carbonate units and 2-phenyl-3,3′-bis(4-hydroxyphenyl) phthalimidine carbonate units, a copolycarbonate comprising bisphenol A carbonate units and siloxane units, or a combination thereof.

6. The polycarbonate composition of claim 1, comprising
10 to 40 weight percent of the virgin polycarbonate; and
60 to 90 weight percent of the purified recycled polycarbonate.

7. The polycarbonate composition of claim 1, further comprising an additive composition.

8. The polycarbonate composition of claim 1, wherein the purified post-consumer recycle polycarbonate is prepared according to a method comprising:
contacting a solution comprising
a recycled polycarbonate composition comprising post-consumer recycle polycarbonate, post-industrial polycarbonate, or a combination thereof, and
a solvent effective to dissolve the post-consumer recycle polycarbonate composition,
with an activated carbon; and
isolating the purified recycled polycarbonate.

9. A molded article comprising the polycarbonate composition of claim 1, wherein the molded article has
an L* value of greater than or equal to 95;
an ΔL* of 1 to 4 units lighter, compared to the same molded article comprising an unpurified recycled polycarbonate;
or both.

10. The molded article of claim 9, wherein the molded article is a lens, cover, sheet, film, or consumer electronic component.

11. A method of making the molded article of claim 9, the method comprising
melt-mixing the purified post-consumer recycle polycarbonate and the virgin polycarbonate; and
forming the molded article.

12. A method of purifying a post-consumer or post-industrial recycle polycarbonate composition, the method comprising:
contacting a solution comprising
a post-consumer or post-industrial recycle polycarbonate composition, and
a solvent effective to dissolve the post-consumer or post-industrial recycle polycarbonate composition,
with an activated carbon to provide a purified post-consumer or post-industrial recycle polycarbonate; and
isolating the purified post-consumer or post-industrial recycle polycarbonate by spraying a solution comprising the post-consumer recycle polycarbonate through a jet, wherein upon exiting the jet, the solution is contacted with steam to vaporize the solvent and provide the purified post-consumer recycle polycarbonate in the form of a wet cake;
wherein a molded article comprising at least 50 weight percent of the purified post-consumer recycle polycarbonate exhibits an L* value of greater than or equal to 95; an ΔL* of 1 to 4 units lighter, compared to the same molded article comprising an unpurified post-consumer recycle polycarbonate; or both.

13. The method of claim 12, wherein the post-consumer or post-industrial recycle polycarbonate composition is present in the solution an amount of 5 to 15 weight percent, based on the total weight of the solution.

14. The method of claim 12, wherein contacting the solution with the activated carbon comprises
adding the activated carbon to the solution to provide a slurry, filtering the slurry to provide a filtered solution, and spraying the filtered solution through the jet to isolate the purified post-consumer recycle polycarbonate; or
passing the solution through a bed of activated carbon.

15. The method of 14, wherein contacting the solution with the activated carbon comprises adding the activated carbon to the solution to provide the slurry, wherein greater than or equal to 0.05 weight percent of the activated carbon is added to the solution, based on the total weight of the post-consumer recycle polycarbonate composition.
